(19) United States
(12) Patent Application Publication
(10) Pub. No.: US 2014/0129190 A1
(43) Pub. Date: May 8, 2014

(54) METHOD, APPARATUS AND COMPUTER PROGRAM PRODUCT FOR LOCATING A SOURCE OF DIFFUSION IN A NETWORK

(71) Applicant: ECOLE POLYTECHNIQUE FEDERALE DE LAUSAN, Lausanne (CH)

(72) Inventors: Pedro Filipe PEREIRA CORREIA PINTO, Ecublens Vd (CH); Patrick Thiran, Belmont-Lausanne (CH); Martin Vetterli, Grandvaux (CH)

(73) Assignee: Ecole Polytechnique Federale de Lausanne EPFL, Lausanne (CH)

(21) Appl. No.: 13/672,382

(22) Filed: Nov. 8, 2012

(51) Int. Cl. G06F 17/11

(52) U.S. Cl. CPC G06F 17/11
USPC 703/2

(57) ABSTRACT

The present invention discloses a method, apparatus and computer program product for locating a source of diffusion in a network, the method comprising providing a model of at least a portion of the network, the network comprising a plurality of nodes, a plurality of edges, and at least one source of diffusion, providing a model of a diffusion process initiated by the at least one source during a time period of interest, and employing a source estimator to determine a location of a source of diffusion in at least a portion of the network based on a plurality of network model parameters characteristic for the at least a portion of the network, and a plurality of diffusion process model parameters characteristic for the provided model of a diffusion process.

### FIELD OF INVENTION

The present invention is directed to a method, apparatus and a computer program product that aid in locating a source of diffusion in a network. In particular, the present invention is directed to a method, apparatus and a computer program product that aid in locating the source of diffusion in a network under the constraint that only a small fraction of the nodes of the network, i.e. a small number of the nodes of the network, are observed.

### BACKGROUND

Localizing the source of a contaminant or a virus is a desirable but challenging task. In nature, many animals are intrinsically capable of performing source localization. Through chemotaxis, for example, certain bacteria can analyze concentration gradients around them in order to quickly move towards the source of a nutrient, or to avoid the source of a poison. Animals such as the salmon and the green sea turtles are capable of using olfaction to navigate in odor plumes, for foraging or reproductive activities.

In certain systems, however the task of localizing the source has to be performed in a network rather than in the continuous space. This is the case, for example, when an infectious disease spreads through human populations across a large region, as observed with the worldwide H1N1 virus pandemic in 2009, or when a poisonous chemical agent spreads through a water supply system or a subway network.

In recent years, a significant effort has been dedicated to studying the dynamics of epidemic outbreaks on networks. In particular, the focus has been on the forward problem of epidemics, more precisely on understanding the diffusion process and its dependence on the rates of infection and cure, as well as on the structure of the network.

The inverse problem, that of inferring the original source of diffusion, given the infection data gathered at some of the nodes in the network has been less studied. The ability to estimate the source is invaluable in helping authorities contain the epidemic or contamination. In this context, in the art there are references discussing the inference of the underlying propagation network, or the inference of the unknown source, in both cases under the assumption that the state of all nodes in the network is known. More recently, in the art the controllability of complex networks was as well considered using appropriately selected driver nodes.

No reference is available in the art that aids in locating the source of diffusion under the practical constraint that only a small fraction of nodes can be observed. This is the case, for example, when locating a spammer who is sending undesired emails over the Internet, where it is clearly impossible to monitor all the nodes. Thus, the main difficulty is to develop tractable estimators that can be efficiently implemented (i.e., with sub-exponential complexity), and that perform well on multiple topologies.

Therefore, what are needed are methods, systems and computer program products capable of accurately providing the location of a source of diffusion, even in complex environments where only a limited number of nodes of the network are available for observation.

### BRIEF SUMMARY OF THE INVENTION

It is therefore an object of the present invention to provide methods, apparatuses and computer program products capable of accurately providing the location of a source of diffusion, in realistic or complex environments where only a limited fraction of nodes of the network are available for observation.

The above-referenced technical problem is solved at least by the method of claim 1, by a system provided by claim 18, and a computer program product of claim 19.

In accordance with a first aspect of the present invention, a method for locating a source of diffusion in a network is provided, the method comprising providing a model of at least a portion of said network, said network comprising a plurality of nodes, a plurality of edges, and at least one source of diffusion, providing a model of a diffusion process initiated by this—source during a time period of interest, and employing a source estimator to determine a location of a source of diffusion in at least a portion of said network, based on a plurality of network model parameters characteristic of said network, and a plurality of diffusion process model parameters characteristic of said provided model of a diffusion process.

In accordance with another aspect of the present invention, a system for locating a source of diffusion in a network is provided, the system comprising at least a data bus system, a memory coupled to the data bus system, wherein the memory comprises a computer usable program code, and a processing unit coupled to the data bus system, wherein the processing unit executes the computer usable program code to provide a model of at least a portion of said network, said network comprising a plurality of nodes, a plurality of edges, and at least one source of diffusion, provide a model of a diffusion process initiated by said at least one source at during a time period of interest, and employ a source estimator to determine a location of a source of diffusion in at least one portion of said network based on a plurality of network model parameters characteristic for said at least a portion of said network, and a plurality of diffusion process model parameters characteristic for said provided model of a diffusion process.

In accordance with a further aspect of the present invention, a computer program product for locating a source of diffusion in a network is provided, comprising a tangible computer usable medium including computer usable program code for locating a source of diffusion in a network, the computer usable program code being used for providing a model of at least a portion of said network, said network comprising a plurality of nodes, a plurality of edges, and at least one source of diffusion, providing a model of a diffusion process initiated by said at least one source during a time period of interest, and employing a source estimator to determine a location of a source of diffusion in at least a portion of said network based on a plurality of network model parameters characteristic for said at least a portion of said network, and a plurality of diffusion process model parameters characteristic for said provided model of a diffusion process.

Other characteristics and advantages of the present invention will be apparent in connection with the dependent claims.

In accordance with the present invention, the network comprises at least one group of interconnected elements, including (but not limited to) a water way, a traffic way, an information exchange way, or an electrical grid. The model of the at least one portion of network is a graph, and the graph is at least one of a finite graph, and an undirected graph. The graph may have a tree representation.

In accordance with an embodiment of the present invention it is assumed that the source of diffusion comprises at least one physical entity that emits at least one of data, a living form, a non-living form, a substance, energy or a wave. The source of diffusion is capable of initiating the diffusion in the network of at least one of data, a living form, a non-living form, a substance, energy or a wave.

In accordance with an embodiment of the present invention a model of the at least one source of diffusion is a random variable with an arbitrary probability distribution over the plurality of nodes. In one embodiment a model of the at least one source of diffusion is a random variable with an uniform probability distribution over the plurality of nodes. Either node pertaining to the plurality of nodes is assumed to constitute a source prior, to the identification of the actual source of diffusion.

In accordance with a further embodiment of the invention the step of providing a model of a diffusion process comprises identifying a plurality of states of the plurality of nodes at a time of interest; identifying, at a time subsequent to the time of interest, a plurality of subsequent states of the plurality of nodes; measuring for a plurality of nodes of interest from which neighboring node and at what time a diffused entity was received; and obtaining based on the identified plurality of states, the identified plurality of subsequent states, the position of the identified neighboring node, and the time of receipt of the diffused entity. The plurality of diffusion process model parameters may comprise a direction of travel of the diffused entity.

In accordance with a further yet embodiment of the invention the step of providing a model of at least a portion of said network comprises placing a plurality of observers at a plurality of nodes of interest in the network, and calculating a plurality of network model parameters indicative of possible paths of diffusion between a source and the plurality of observers. A location of the plurality of observers is known.

In accordance with the present invention, the source estimator is a maximum likelihood estimator. The placement of the source has an arbitrary distribution over the nodes of the network. The identified plurality of states of the plurality of nodes at a time of interest and of the plurality of nodes at a time subsequent to the time of interest comprises an informed state, if said node is in receipt of the diffused entity from a neighboring node, and an ignorant state, if the node is not in receipt of the diffused entity from a neighboring node. Each one of the plurality of observers is configured to measure from which neighboring node and at what time the diffused entity is received. Further, the plurality of observers is configured to identify a direction from which the diffused entity arrives to each of said plurality of observers.

The present invention also proposes a computer data carrier storing presentation content created with the methods of the present invention.

Other characteristics and advantages of the present invention will be apparent in connection with the following drawings and the following description.

### BRIEF SUMMARY OF THE FIGURES

For a more complete understanding of the present invention, the objects and advantages thereof, reference is now made to the following descriptions taken in conjunction with the accompanying drawings, in which:

FIG. 1 is a representation of a portion of an exemplary network.

FIG. 2 is a flow chart representation of the method for locating a source of diffusion in a network, in accordance with an embodiment of the present invention.

FIG. 3 is the illustration of an embodiment of a data processing system in which a method for locating a source of diffusion in a network, in accordance with an embodiment of the present invention, may be implemented.

FIG. 4a represents the hydrographic map of the KwaZulu-Natal province.

FIG. 4b is a graphical model of the Thukela river basin.

Non-limiting and non-exhaustive embodiments of the present invention are described with reference to the above referenced figures, wherein like reference numerals refer to like parts throughout the various views unless otherwise specified. The order of description should not be construed as to imply that these operations are necessarily order-dependent.

### DETAILED DESCRIPTION OF THE INVENTION

Because of the tremendous size of many real networks, such as the internet or the human social graph, it is usually infeasible to observe the state of all nodes in a network. In this case, how can we localize the source of diffusion in a real network? As it will be shown in the following the location of the source will be estimated from measurements collected by sparsely placed observers.

In this document, a strategy of localization of a diffusion source is presented that is optimal for arbitrary networks and their subscribed trees, achieving maximum probability of correct localization.

The present invention provides methods, apparatuses and computer program products capable of accurately providing the location of a source of diffusion, even in complex environments where only a limited number or fraction of nodes of the network are available for observation.

Prior to discussing in detail these means proposed in accordance with the present invention, a source of diffusion and its environment will be discussed herein. Herein it is assumed that the task of locating the source has to be performed in a network, rather than in a continuous space. This is the case for example when the task of locating a source of diffusion is performed in connection with at least one of a water way, a traffic way, an information exchange way, or an electrical grid. In these environments it is assumed that the source of diffusion comprises at least one physical entity that emits at least one of data, a living form, a non-living form, a substance, energy or a wave. The source of diffusion is capable of initiating the diffusion in the network, by the physical entity, of at least one of data, a living form, a non-living form, a substance, energy or a wave.

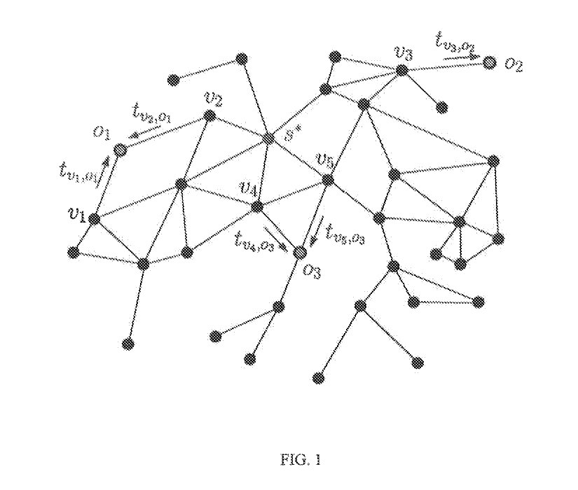

To this end, we, refer to the illustration of FIG. 1. FIG. 1 is a representation of a portion of an exemplary network.

As it may be seen in FIG. 1 the underlying network on which diffusion takes place is modelled by a finite, undirected graph

G={V,E}

where the vertex set V has N nodes, and the edge set E has L edges.

In FIG. 1, the elements v1, v2 and v3 are a plurality of exemplary nodes N and all connections or links between nodes are assumed to be the edges of the graph.

As it may be seen from FIG. 1, the representation of the network is made via an arbitrary graph of interconnected elements. As it is known in the art, in the most common sense of the term, a graph is an ordered pair G=(V, E) comprising a set V of vertices or nodes together with a set E of edges or lines, which are 2-element subsets of V. An edge is related with two vertices, and the relation is represented as an unordered pair of the vertices with respect to the particular edge. To avoid ambiguity, this type of graph may be described precisely as undirected and simple.

E is a set together with a relation of incidence that associates with each edge two vertices. E may also be a multiset of unordered pairs of (not necessarily distinct) vertices.

The vertices belonging to an edge are called the ends, endpoints, or end vertices of the edge. A vertex may exist in a graph and not belong to an edge. V and E are usually taken to be finite. The order of a graph is |V| (the number of vertices). A graph's size is |E|, the number of edges. The degree of a vertex is the number of edges that connect to it, where an edge that connects to the vertex at both ends (a loop) is counted twice.

In connection with the present invention, and as illustrated in FIG. 1, a model of the at least one portion of the network is a graph that is a finite and undirected graph.

The graph G is assumed to be known, at least approximately, and it is modeled after practical examples, such as rumors spreading in a social network, or electrical perturbations propagating on the electrical grid.

As it may be noted in FIG. 1 the represented graph also comprises a source s* of diffusion. Although in the exemplary representation of FIG. 1 only one source is provided, the present invention is not limited to this embodiment. Since a plurality of sources may concomitantly present and are all capable of initiating the diffusion in the network of the physical entity of interest, independently from each other. The solutions and means of the present invention are capable of accurately locating not only one source of diffusion, but as well multiple sources of diffusion. In one embodiment multiple sources of diffusion are located under the constraint that each source of diffusion initiates the diffusion in the network of the same physical entity.

In connection with the representation made in FIG. 1, the information source, pertaining to the graph G, is a vertex that originates at least one of data, a living form, a non-living form, a substance, energy or a wave, and combination thereof. In the following portions of this document for the simplicity of the language used herein the “at least one of data, a living form, a non-living form, a substance, energy or a wave, and a combination thereof” will be referred to collectively or individually with the term “information”. In the context of the present invention the term “information” is not to be construed narrowly to mean only data, but it is to be construed broadly to refer to either one or a combination of data, a living form, a non-living form, a substance, energy or a wave.

The information source s is the vertex that initiates the diffusion.

As it may be seen in FIG. 1 at a time t, the information source s initiates the diffusion of information. In this example, there are nodes where three observers have been placed, which measure from which neighbors and at what time they received the information. The goal is to estimate, from these observations, which node in the graph is the information source. The source initiates a diffusion process during a period of time of interest for the purposes of observation. At a time of interest t the nodes of the network will have certain states, and a time ts, subsequent to time t and subscribing to the time period of interest, the nodes of the network may have the same or changed states. The arbitrary graph G illustrated in FIG. 1 is employed to provide a model of at least a portion of the network where diffusion takes place and wherein the aim is to localize the source of diffusion.

As it may be seen at least in connection with the graph of FIG. 1 the portion of the network is modeled as comprising a plurality of nodes, a plurality of edges and at least one source of diffusion. Although a large plurality of nodes and edges may be identified for the graph illustrated in FIG. 1 it is assumed that only a limited number of nodes, such as nodes O1 to O3, are accessible for observation. Any conclusions that will be drawn regarding the nodes and vertices of FIG. 1 may be extrapolated to the entire network.

Such network representations, similar to the representation provided in FIG. 1 may be employed in connection with various practical scenarios. Exemplarily, this representation may be used to locate the source of diffusion of cholera, such it as the case of cholera outbreak that occurred in the KwaZulu-Natal province, South Africa, in 2000. The epidemic was caused by a strain of Vibrio cholerae, which colonizes the human intestine and is transmitted through contamination of aquatic environments. The data set was provided by the KwaZulu-Natal Health Department, and consists of each single cholera case, specified by the date and health subdistrict where it occurred. To perform source localization, a network model of the water basin in said province was represented. The nodes of the graph may represent human communities and associated water reservoirs, in which the disease can be diffused and grow. The edges of the graph may represent hydrological links between the communities. The propagation parameters for this bacteria are known. In this exemplary case, source localization is performed by monitoring the daily cholera cases reported in K communities, the observers. The observers are selected according to an arbitrary strategy. In one embodiment the observers can be selected uniformly at random due to the lack of a priori information about the source location. Due to the vast region affected, only approximately 20% of the communities were accessible for observation. As it will be shown in the following, by employing the methods and means of the present invention, accurate localization is possible with an average error of less than four hops between the estimated source and the first infected community. This small distance error may enable a faster emergency response from the authorities in order to contain an outbreak.

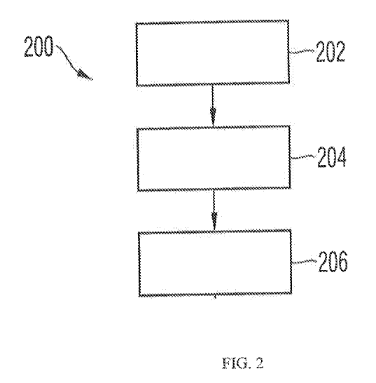

In the following, the method for locating a source of diffusion in a network will be explained utilizing the notions introduced above in connection with the graph representation for a network made in FIG. 1, and in connection with the flow chart representation made in FIG. 2.

FIG. 2 is a flow chart representation of the method for locating a source of diffusion in a network, in accordance with an embodiment of the present invention.

Method 200 for locating a source of diffusion in a network comprises at least the steps of providing 202 a model of at least a portion of said network, the network comprising a plurality of nodes, a plurality of edges, and at least one source of diffusion, providing 204 a model of a diffusion process initiated by the at least one source during a time period of interest, and employing 206 a source estimator to determine a location of a source of diffusion in at least a portion of the network based on a plurality of network model parameters characteristic for the at least a portion of the network, and a plurality of diffusion process model parameters characteristic for the provided model of a diffusion process.

The method for locating a source of diffusion on a network comprises the step 202 of providing a model of at least a portion of the network. As it has been explained in detail in connection with FIG. 1 the network comprises a plurality of nodes, a plurality of edges, and at least one source of diffusion. The model of the at least one portion of the network is a graph, and the graph is at least one of a finite and an undirected graph.

The model of the source of diffusion takes into account that the information source is part of the graph and it is the vertex that originates the information and initiates the diffusion. The source may be modeled as a random variable (RV) whose prior distribution is arbitrary over the set V. As a particular example, any node in the network could be equally likely to be the source, a priori.

The step of providing a model of at least a portion of the network also comprises placing a plurality of observers at a plurality of nodes of interest in the network, and calculating a plurality of network model parameters indicative of possible paths of diffusion between the source and the plurality of observers. The location of the plurality of observers may be known.

$$O {=}^{Δ} {\{ {o}_{k} \}}_{k = 1}^{K} ⋐ G$$

denotes the set of K observers, whose location on G is chosen or known. Each observer measures from which neighbor and at what time it received the information. Specifically, if tv,o denotes the absolute time at which observer O receives the information from its neighbor v, then the observation set is composed of tuples of direction and time measurements, such as

$$Θ {=}^{Δ} \{ ( o , v , {t}_{v , o} ) \}$$

for all oεO and vεV(o).

Method 200 for locating a source of diffusion in a network comprises as well the step of providing 204 a model of a diffusion process initiated by the at least one source during a time period of interest. In accordance with one embodiment of the present invention the step of providing a model of a diffusion process comprises at least identifying a plurality of states of the nodes at a time of interest, identifying, at a time subsequent to the time of interest a plurality of subsequent states of the plurality of nodes, measuring for a plurality of nodes of interest from which neighboring node and at what time a diffused entity was received, and obtaining based on the identified plurality of states, the identified plurality of subsequent states, the position of the identified neighboring node and the time of receipt of the diffused entity.

In one embodiment the plurality of diffusion process model parameters comprises a direction of travel of the diffused entity.

Specifically, at time of interest t, each vertex u pertaining to the graph has one of two possible states: (i) informed, if it has already received the information from any neighbor node; or (ii) ignorant, if it has not been informed so far.

If V(u) denotes the set of vertices directly connected to u, for example the neighborhood or vicinity of u, and u is assumed to be in the ignorant state at a time of interest t and, at a time to subsequent to the time of interest receives the information for the first time from one neighbor, the state of the node becomes informed. Then it is likely that u will retransmit the information to all its other neighbors, so that each neighbor vεV₍ᵤ₎\s receives the information at time tᵤ+θᵤᵥ, where θᵤᵥ denotes the random propagation delay associated with edge uv.

The RVs{θᵤᵥ} for different edges uv have a known, arbitrary joint distribution. The diffusion process is initiated by the source s at an unknown time. This diffusion model is general enough to accommodate various scenarios encountered in practice.

Method 200 for locating a source of diffusion in a network comprises as well the step of providing 206 employing a source estimator to determine a location of a source of diffusion in at least a portion of said network based on a plurality of network model parameters characteristic for said at least a portion of said network, and a plurality of diffusion process model parameters characteristic for said provided model of a diffusion process.

In accordance with the present invention the source location is recovered from the measurements taken at the observers by adopting a maximum probability of localization criterion, which corresponds to designing an estimator ŝ(·) such that the localization probability

$${P}_{loc} {=}^{Δ} P ( \hat{s} ( 𝒪 ) = {s}^{*} )$$

is maximized. Since the source can be considered to be uniformly random over G, the optimal estimator is the maximum likelihood (ML) estimator,

$$\hat{s} ( 𝒪 ) = {argmax}_{s ∈ 𝒢} P ( 𝒪 \vert {s}^{*} = s ) = {argmax}_{s ∈ 𝒢} {\sum }_{{Π}_{s}} P ( {Π}_{s} \vert {s}^{*} = s ) \times \int … \int g ( {θ}_{1} , … , {θ}_{L} , 𝒪 , {Π}_{s} , s ) d {θ}_{1} … d {θ}_{L} . \qquad ( 1 )$$

In formula (1) Πₛ is the set of all possible paths { [symbol] s,oₖ}ₖ₌₁^{K} between the source s and the observers in the graph G. In formula 1 the set {θₗ}ₗ₌₁^{L} represents the random propagation delays for all L edges of graph G, and g is a deterministic function that depends on the joint distribution of the propagation delays.

The maximum likelihood estimator proposed in accordance with eq. 1 is performing averages over two different sources of randomness: (a) the uncertainty in the paths that the information takes to reach the observers, and (b) the uncertainty in the time that the information takes to cross the edges of G. Due the combinatorial nature of (1), its complexity increases exponentially with the number of nodes in G, and is therefore intractable.

Therefore, in accordance with the present invention is proposed a strategy of complexity O(N) that is optimal for general trees, and a strategy of complexity O(N³) that is suboptimal for general graphs.

The present invention proposes first the case of an underlying tree T as a representation for the portion of network that is of interest. Because a tree does not contain cycles, only a subset Oₐ⊂O of the observers will receive information emitted by the unknown source. We call Oₐ={oₖ}ₖ₌₁^{K}^{ₐ} the set of Ka observers. The observations made by the nodes in Oa provide two types of information:

(a) the direction in which information arrives to the observers, which uniquely determines a subset of [symbol] ₐ⊂ [symbol] of regular nodes, called subtree; and
(b) the timing at which the information arrives to the observers, denoted by {tₖ}ₖ₌₁^{K}^{ₐ}, which is used to localize the source within the set Ta.

It is also convenient to label the edges of Ta as

E( [symbol] ₐ)={1, 2, . . . , Eₐ}

so that the propagation delay associated with edge iεE is denoted by the RV θᵢ.

The propagation delays associated with the edges of T are independent identically distributed RVs with Gaussian distribution [symbol] (μ, σ²), where the mean μ and variance σ² are known.

With the aid of these definitions, the present invention proposes an optimal estimation method for locating a source of diffusion in a network for general trees, and a method for locating a source of diffusion in a network that takes into account the presence of multiple cascades.

In the following both said methods will be described in detail, starting herewith first with a description of an optimal estimation method for locating a source of diffusion in a network for general trees.

For a general propagation tree T, the optimal estimator is given by

$$\hat{s} = {argmax}_{s ∈ {𝒯}_{a}} {μ}_{s}^{T} {Λ}^{- 1} ( d - \frac{1}{2} {μ}_{s} ) \qquad ( 2 )$$

where d is the observed delay, μ is the deterministic delay, and Λ is the delay covariance, given by

[d]ₖ=tₖ₊₁−tₖ (3).

The deterministic delay is calculated via

[μₛ]ₖ=μ(| [symbol] (s,oₖ₊₁)|−| [symbol] (s,o₁)|) (4)

and the delay covariance is given by

$${[ Λ ]}_{k , i} = {σ}^{2} \times \{ \begin{matrix}\vert 𝒫 ( {o}_{1} , {o}_{k + 1} ) \vert , & k = i , \\ \vert 𝒫 ( {o}_{1} , {o}_{k + 1} ) ⋂ 𝒫 ( {o}_{1} , {o}_{i + 1} ) \vert , & k \neq i ,\end{matrix} \qquad ( 5 )$$

for k, i=1, . . . , Kₐ−1, with | [symbol] (u,v)| denoting the for number of edges (or the length) of the path connecting vertices u and v.

The μₛ, and Λ represent, respectively, the mean and covariance of the observed delay d (a random vector), when node s is chosen as the source.

The optimal estimation method for locating a source of diffusion in a network for general trees essentially proposes to reduce the estimation formula (1) to a tractable expression whose parameters can be simply obtained from path lengths in the tree T. Furthermore, the complexity of equations (2) to (5) scales as O(N) with the number of nodes N in the tree. In practice, the Gaussian condition for the propagation delays can often be relaxed to non-Gaussian scenarios. The estimator in the equation (1) can be shown to be near-optimal as long as the observers are sparse—which is often verified in practice—and the propagation delays have finite moments.

The sparsity implies that the distance between observers is large, and sods the number of RVs of the sum

$${d}_{k} = {t}_{k + 1} - {t}_{1} = {\sum }_{i ∈ 𝒫 ( {s}^{*} , {o}_{k + 1} )} {θ}_{i} - {\sum }_{i ∈ 𝒫 ( {s}^{*} , {o}_{1} )} {θ}_{i}$$

Then, the observer delay vector d can be closely approximated by a Gaussian random vector, due to the central limit theorem.

The means and methods of the present invention may be successfully applied to the most general case of source estimation on an arbitrary graph G. When the information is diffused on the network, there is a tree corresponding to the first time each node gets informed, which spans all nodes in G. Since the number of spanning trees can be exponentially large, in accordance with the present invention is introduced an approximation by assuming that the actual diffusion tree is a breadth-first search (BFS) tree.

This assumption corresponds to assuming that the information travels from the source to each observer along a minimum-length path. The applicable maximum likelihood estimator is written as

$$\hat{s} = {argmax}_{s ∈ 𝒢} 𝒮 ( s , d , {𝒯}_{bfs , s} ) , \\ where \\ 𝒮 = {μ}_{s}^{T} {Λ}_{s}^{- 1} ( d - \frac{1}{2} {μ}_{s} ) \qquad ( 6 )$$

Wherein parameters μₛ the deterministic delay, and Λ the delay covariance being computed with respect to the BFS tree T_{bfs,s} rooted at s. The complexity of equation (6) scales subexponentially with N.

The accuracy of locating the source of diffusion in a network via the method proposed by the present invention shows a strong dependence upon the structure of the network, the density and placement of the observers, and the observation of multiple information cascades.

The proposed estimator may be applied to various synthetic networks, such as the Apollonian network, the Barabasi-Albert network, and the Erdos-Renyi network. Upon application of the estimator to various synthetic networks it has been observed that the estimator performs the best in scale-free networks (such as the Barabasi-Albert and the Apollonian models) in some cases requiring as few as 4% of observers to achieve a localization probability of 90%. This is because scale-free networks exhibit “hubs” with large degrees, which can be picked as observers and are able to receive a large amount of information about the source. If the network is not scale free (such as the Erdos-Renyi model), or the observers are placed uniformly at random, then more observers are necessary to achieve the same localization performance.

So far in this document the above descriptions were made under the assumption that the source transmits only one message. However, in many scenarios, the source emits different messages over time, which diffuse independently over the network. These information cascades can be gathered and exploited by the observers, as revealed by the following proposition.

As mentioned above, with the aid of the above discussed definitions, the present invention proposes an optimal estimation method for locating a source of diffusion in a network for general graphs, and a method for locating a source of diffusion in a network that takes into account the presence of multiple cascades.

Concerning the method for locating a source of diffusion in a network that takes into account the presence of multiple cascades the present invention stipulates that if the source s transmits C independent cascades of information on a tree T, then the probability of correct localization Ploc achieved by the maximum likelihood estimator is given by

P_{loc}=Pₘₐₓ−O(e^{-aC})

where Pmax is the maximum probability of localization achieved under deterministic propagation, and a is a constant.

The proposition shows that as the observers collect more information from successive cascades, they can average out the variance associated with random propagation, and approach the localization performance of the deterministic scenario (Pmax) at a rate that is at least exponential. As such the observers can achieve higher accuracy of localization by waiting for a longer time, over which they can observe more cascades.

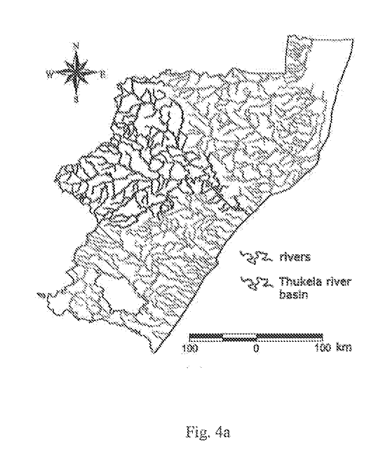

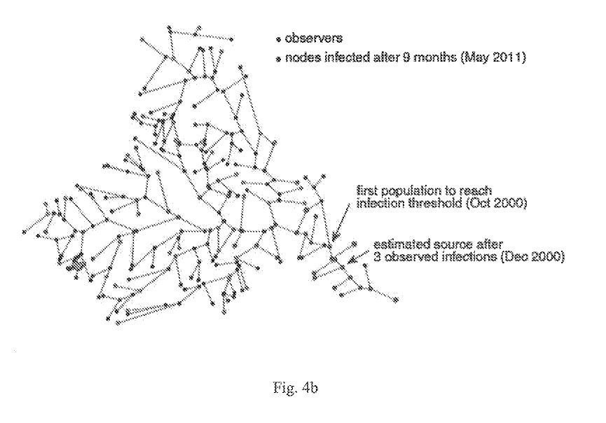

The means and method of the present invention will be discussed in connection with real, measured data, as it relates to the well documented case of cholera outbreak that occurred in the KwaZulu-Natal province, South Africa, in 2000. The epidemic was caused by a strain of Vibrio cholerae, which colonizes the human intestine and is transmitted through contamination of aquatic environments. The data set was provided by the KwaZulu-Natal Health Department, and consists of each single cholera case, specified by the date and health subdistrict where it occurred. To perform source localization, we consider a network model of the basin, illustrated in connection with FIGS. 4a and 4b.

FIG. 4a represents the hydrographic map of the KwaZulu-Natal province. The dot corresponds to the location of the first reported cases of cholera. FIG. 4b represents a graphical model of the Thukela river basin. Nodes represent small communities and associated water reservoirs, in which the disease can be diffused and grow. The edges reflect the transport of cholera between neighboring communities, due to hydrological flow and human mobility. To localize the source of the outbreak, 20% of the communities were monitored, selected at random. With 20% of observers, an average error of less than four hops is achieved. It is of note that the first infected community is not necessarily the source of the outbreak, due to the delay between the infection and the actual reporting of the disease.

The nodes represent human communities and associated water reservoirs, in which the disease can be diffused and grow. The edges of the graph represent hydrological links between the communities. The propagation parameters for this bacteria were obtained from past epidemics.

Source localization is performed by monitoring the daily cholera cases reported in K communities (the observers). These are selected uniformly at random, due to the lack of a priori information about the source location. It has been observed that by monitoring only 20% of the communities, an average error of less than four hops is achieved between the estimated source and the first infected community. This small distance error may enable a faster emergency response from the authorities in order to contain an outbreak.

These results suggest that a sparse deployment of observers may provide an effective alternative to the individual monitoring (either human or automatic) of all nodes in a network. Despite these advantages, in some scenarios, it may be difficult to exactly determine the underlying graph on which diffusion occurs. In a cholera outbreak, for example, the diffusion of the bacteria is also influenced by the long-range movement of infected individuals, in addition to the basic hydrological transport. The choice of observers in the network strongly affects the performance of the proposed algorithm. Optimal strategies for observer placement are necessary. Nevertheless, the results indicate that source localization in large networks, a seemingly impossible task with only a few sensors is indeed feasible, both in terms of localization accuracy and computational cost.

The exemplary embodiment and the results obtained by the application of the means and methods of the invention will be explain herein in more detail in connection with the exemplary embodiment of the invention. The dataset employed consists of a record of each single cholera case since August 2000, specified by the date and health subdistrict where it occurred. These reports were mapped onto a graphical model of the Thukela river basin−a tree T composed of N=287 nodes. All the channels of perennial rivers are considered edges, and all the endpoints of these channels are considered as nodes. The cholera bacteria is diffused across this network by a multitude of mechanisms, including downstream hydrological transport, and mobility of infected individuals. The forward analysis shows that the overall drift of the bacteria is only 8% downstream. Therefore, this bias is ignored and the tree T representing the basin is considered to be undirected.

The spatial drift v of cholera was estimated at approximately 3 km/day. A given population is considered to be infected whenever the cumulative number of cholera cases since August 2000 exceeds the threshold of 50 cases. The propagation delay θᵤᵥ between communities u and v is modeled according to a Gaussian

RV [symbol] (μᵤᵥ,σᵤᵥ²).

The mean μᵤᵥ is approximated by rᵤᵥΘ/v where rᵤᵥ is the physical distance between communities u and v. The standard deviation σᵤᵥ is considered proportional to the mean μᵤᵥ, with a fixed propagation ratio

$$β {=}^{Δ} {σ}_{uv} / {μ}_{uv} = 0.5$$

The system parameters of cholera outbreak case study were assumed as follows:

Parameter b, Value b≠0, Unit, Description Transport bias;
Parameter v, Value 3.0, Unit km/day, Description Spatial drift of Vibrio cholerae;
Parameter Θ, Value 50, Unit cases, Description Infection threshold at each node;
Parameter β, Value 0.5 Unit, Description Ratio between standard deviation and mean of propagation delay;
Parameter σₘ, Value 1, Unit days, Description Standard deviation of the measurement delay;
Parameter Kₘₐₓ, Value 3, Unit observers, Description Maximum number of observers used for source localization;
Parameter dₘₐₓ, Value 2, Unit hops, Description Maximum search distance to first infected observer.

The general source estimator in

$$\hat{s} = {argmax}_{s ∈ {𝒯}_{a}} \frac{exp ( - \frac{1}{2} {( d - {μ}_{s} )}^{T} {Λ}_{s}^{- 1} ( d - {μ}_{s} ) )}{{\vert {Λ}_{s} \vert}^{1 / 2}}$$

previously discussed cannot be directly applied here because of two particularities of the cholera diffusion process: i) the direction of arrival of the vibrios cannot be observed, only its timing, and ii) there is a non-negligible measurement delay between infection by the vibrios and reporting to local health authorities.

The general source estimator can be extended in order to accommodate these differences, as follows.

Source estimator for general trees (jointly-Gaussian diffusion, Gaussian IID measurement delays) is provided as

$$\hat{s} = {argmax}_{s ∈ 𝒯} \frac{exp ( - \frac{1}{2} {( d - {μ}_{s} )}^{T} {Λ}_{s}^{- 1} ( d - {μ}_{s} ) )}{{\vert {Λ}_{s} \vert}^{1 / 2}}$$

$$with$$

$${μ}_{s} = {C}_{s} {μ}_{θ}$$

$${Λ}_{s} = {C}_{s} {Λ}_{θ} {C}_{s}^{T} + ( {1}_{K - 1} + {I}_{K - 1} ) \cdot {σ}_{m}^{2}$$

where 1n is the n×n matrix of ones, In is the n×n identity matrix, and σₘ is the standard deviation of the measurement delay.

Two additional optimizations were performed in connection with this exemplary embodiment of the invention. First, since it is often desirable to localize and limit the outbreak as soon as possible, we do not wait until all K observers were infected in order to estimate the source location. Instead, the location estimation was performed as soon as the first Kmax=3 observers were infected. Second, since it is likely that the actual source is in the neighborhood of the first infected observer, the maximization of the source estimator was limited to all nodes within dmax=2 hops of the first infected observer.

The resulting error distance is a random variable, since it depends on the (random) location of the observers.

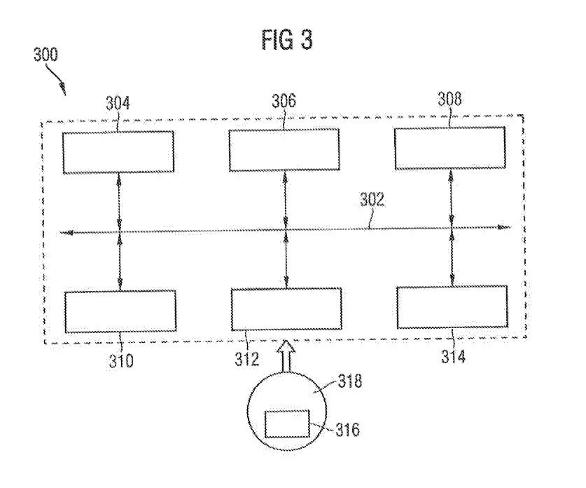

FIG. 3 is an embodiment of a data processing system 300 in which an embodiment of a method for locating a source of diffusion in a network may be implemented. The data processing system 300 of FIG. 3 may be located and/or otherwise operate at any node of a computer network, that may exemplarily comprise clients, servers, etc., and it is not illustrated in the figure. In the embodiment illustrated in FIG. 3, data processing system 300 includes communications fabric 302, which provides communications between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 304 may be implemented using one or more heterogeneous processor systems in which a main processor is present with secondary processors on a single chip. As another illustrative example, the processor unit 304 may be a symmetric multi-processor system containing multiple processors of the same type.

In some embodiments, the memory 306 shown in FIG. 3 may be a random access memory or any other suitable volatile or non-volatile storage device. The persistent storage 308 may take various forms depending on the particular implementation. For example, the persistent storage 308 may contain one or more components or devices. The persistent storage 308 may be a hard drive, a flash memory, a rewritable optical disk, a rewritable magnetic tape, or some combination of the above. The media used by the persistent storage 308 also may be removable such as, but not limited to, a removable hard drive.

The communications unit 310 shown in FIG. 3 provides for communications with other data processing systems or devices. In these examples, communications unit 310 is a network interface card. Modems, cable modem and Ethernet cards are just a few of the currently available types of network interface adapters. Communications unit 310 may provide communications through the use of either or both physical and wireless communications links.

The input/output unit 312 shown in FIG. 3 enables input and output of data with other devices that may be connected to data processing system 300. In some embodiments, input/output unit 312 may provide a connection for user input through a keyboard and mouse. Further, input/output unit 312 may send output to a printer. Display 314 provides a mechanism to display information to a user.

Instructions for the operating system and applications or programs are located on the persistent storage 308. These instructions may be loaded into the memory 306 for execution by processor unit 304. The processes of the different embodiments may be performed by processor unit 304 using computer implemented instructions, which may be located in a, memory, such as memory 306. These instructions are referred to as program code, computer usable program code, or computer readable program code that may be read and executed by a processor in processor unit 304. The program code in the different embodiments may be embodied on different physical or tangible computer readable media, such as memory 306 or persistent storage 308.

Program code 316 is located in a functional form on the computer readable media 318 that is selectively removable and may be loaded onto or transferred to data processing system 300 for execution by processor unit 304. Program code 316 and computer readable media 318 form a computer program product 320 in these examples. In one example, the computer readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, the computer readable media 318 also may take the form of a persistent storage, such as a hard drive, a thumb drive, or a flash memory that is connected to data processing system 300. The tangible form of computer readable media 318 is also referred to as computer recordable storage media. In some instances, computer readable media 318 may not be removable.

Alternatively, the program code 316 may be transferred to data processing system 300 from computer readable media 318 through a communications link to communications unit 310 and/or through a connection to input/output unit 312. The communications link and/or the connection may be physical or wireless in the illustrative examples. The computer readable media also may take the form of non-tangible media, such as communications links or wireless transmissions containing the program code.

The different components illustrated for data processing system 300 are not meant to provide architectural limitations to the manner in which different embodiments may be implemented. The different illustrative embodiments may be implemented in a data processing system including components in addition to or in place of those illustrated for data processing system 300. Other components shown in FIG. 3 can be varied from the illustrative examples shown. For example, a storage device in data processing system 300 is any hardware apparatus that may store data. Memory 306, persistent storage 308, and computer readable media 318 are examples of storage devices in a tangible form.

Therefore, as explained at least in connection with FIG. 3 the present invention is as well directed to a system for locating a source of diffusion in a network, a computer program product for locating a source of diffusion in a network and a computer data carrier.

The system for locating a source of diffusion in a network, proposed in accordance with one embodiment of the present invention comprises at least a data bus system, a memory coupled to the data bus system, wherein the memory comprises a computer usable program code, and a processing unit coupled to the data bus system, wherein the processing unit executes the computer usable program code to provide a model of at least a portion of said network, the network comprising a plurality of nodes, a plurality of edges, and at least one source of diffusion, provide a model of a diffusion process initiated by the at least one source at during a time period of interest, and employ a source estimator to determine a location of a source of diffusion in the at least one portion of the network based on a plurality of network model parameters characteristic for the at least a portion of said network, and a plurality of diffusion process model parameters characteristic for the provided model of a diffusion process.

The computer program product for locating a source of diffusion in a network, proposed in accordance with another embodiment of the present invention comprises a tangible computer usable medium including computer usable program code for locating a source of diffusion in a network, the computer usable program code being used for providing a model of at least a portion of said network, the network comprising a plurality of nodes, a plurality of edges, and at least one source of diffusion, providing a model of a diffusion process initiated by the at least one source during a time period of interest, and employing a source estimator to determine a location of a source of diffusion in at least a portion of the network based on a plurality of network model parameters characteristic for the at least a portion of the network, and a plurality of diffusion process model parameters characteristic for the provided model of a diffusion process.

In accordance with a further embodiment of the present invention is provided for a computer data carrier storing presentation content created while employing the methods of the present invention.

Although the present invention has been described in more detail in connection with its embodiment for locating the source of a cholera outbreak, and as such in connection with an embodiment a source of diffusion that emits a living form, the diffused virus, the present invention finds applicability of connection with many other fields. For example the source of diffusion may emit data, information, other living forms apart from viruses, non-living forms such as various gases or fluids, a plurality of useful or on the opposite, poisonous substances, energy, a wave or any combination of the above. As such the diffusion takes place along general networks, water ways, traffic ways, either naval, air or auto traffic ways, or either human or animals, an information exchange way, an electrical grid or any possible combination of the above. Therefore, the means and the methods proposed by the present invention may be equally employed for identifying the source of diffusion of a rumor on Facebook, the source of poisonous gas in a metro system, the source of contaminated water in a water supply system or the source of a disturbance on an electrical grid.

As it has been shown above, at least in connection with the exemplary embodiment of the present invention, accurate source localization is a large network is feasible both in terms of localization accuracy and computational cost despite the fact that only a few nodes of said network might be accessible for observation.

What is claimed is:

1. A method for locating a source of diffusion in a network, comprising:
providing a model of at least a portion of said network, said network comprising a plurality of nodes, a plurality of edges, and at least one source of diffusion,
providing a model of a diffusion process initiated by said at least one source during a time period of interest, and employing a source estimator to determine a location of a source of diffusion in at least a portion of said network based on a plurality of network model parameters characteristic for said at least a portion of said network, and a plurality of diffusion process model parameters characteristic for said provided model of a diffusion process.

2. The method of claim 1, wherein said network comprises at least one of a water way, a traffic way, an information exchange way, and an electrical grid.

3. The method of claim 1, wherein said model of said at least one portion of said network is a graph, and wherein said graph is at least one of a finite graph, and a undirected graph.

4. The method of claim 3, wherein said graph has a tree representation.

5. The method of claim 1, wherein said source of diffusion comprises at least one physical entity that emits at least one of data, a living form, a non-living form, a substance, energy or a wave, and
wherein said source of diffusion is capable of initiating the diffusion in the network by said at least one of a physical entity of at least one of data, a living form, a non-living form, a substance, energy or a wave.

6. The method of claim 1, wherein a model of said at least one source of diffusion is a random variable with an arbitrary distribution over said plurality of nodes.

7. The method of claim 1, wherein either node of said plurality of nodes is assumed to constitute a source prior, to the identification of the source of diffusion.

8. The method of claim 1, wherein the step of providing a model of a diffusion process comprises:
identifying a plurality of states of said plurality of nodes at a time of interest;
identifying, at a time subsequent to said time of interest a plurality of subsequent states of said plurality of nodes;
measuring for a plurality of nodes of interest of said plurality of nodes from which neighboring node and at what time a diffused entity was received, and
obtaining based on the identified plurality of states, the identified plurality of subsequent states, the position of the identified neighboring node and the time of receipt of the diffused entity.

9. The method of claim 8, wherein said plurality of diffusion process model parameters comprises a direction of travel of said diffused entity.

10. The method of claim 1, wherein the step of providing a model of at least a portion of said network comprises:
placing a plurality of observers at a plurality of nodes of interest in said network, and
calculating a plurality of network model parameters indicative of possible paths of diffusion between a source and the plurality of observers.

11. The method of claim 10, wherein a location of said plurality of observers is known.

12. The method of claim 1, wherein said source estimator is a maximum likelihood estimator.

13. The method of claim 1, wherein the placement of the source has an arbitrary distribution over said at least a portion of said network.

14. The method of claim 8, wherein said identified plurality of states of said plurality of nodes at a time of interest and of said plurality of nodes at a time subsequent to the time of interest comprises an informed state, if said node is in receipt of said diffused entity from a neighboring node, and an ignorant state, if said node is not in receipt of the diffused entity from a neighboring node.

15. The method of claim 10, wherein each one of said plurality of observers is configured to measure from which neighboring node and at what time the diffused entity is received.

16. The method of claim 15, wherein said plurality of observers is configured to identify a direction from which said diffused entity arrives to each of said plurality of observers.

17. The method of claim 1, wherein a localization accuracy is affected by a plurality of network parameters, said plurality of network parameters including a structure of the network, a density of observers, and a number of observed cascades in said network.

18. A system for locating a source of diffusion in a network, comprising:
at least a data bus system,
a memory coupled to the data bus system,
wherein the memory comprises a computer usable program code, and
a processing unit coupled to the data bus system,
wherein the processing unit executes the computer usable program code to provide a model of at least a portion of said network, said network comprising a plurality of nodes, a plurality of edges, and at least one source of diffusion,
provide a model of a diffusion process initiated by said at least one source at during a time period of interest, and employ a source estimator to determine a location of a source of diffusion in at least one portion of said network based on a plurality of network model parameters characteristic for said at least a portion of said network, and a plurality of diffusion process model parameters characteristic for said provided model of a diffusion process.

19. A computer program product for locating a source of diffusion in a network, comprising:
a tangible computer usable medium including computer usable program code for locating a source of diffusion in a network, the computer usable program code being used for providing a model of at least a portion of said network, said network comprising a plurality of nodes, a plurality of edges, and at least one source of diffusion,
providing a model of a diffusion process initiated by said at least one source during a time period of interest, and employing a source estimator to determine a location of a source of diffusion in at least a portion of said network based on a plurality of network model parameters characteristic for said at least a portion of said network, and a plurality of diffusion process model parameters characteristic for said provided model of a diffusion process.

20. A computer data carrier storing presentation content created with the method of claim 1.
